(19) United States
(12) Patent Application Publication
(10) Pub. No.: US 2018/0011797 A1
(43) Pub. Date: Jan. 11, 2018

(54) MEMORY SHARING METHOD OF VIRTUAL MACHINES BASED ON COMBINATION OF KSM AND PASS-THROUGH

(71) Applicant: MASSCLOUDS INNOVATION RESEARCH INSTITUTE (BEIJING) OF INFORMATION TECHNOLOGY, Beijing (CN)

(72) Inventors: Lei SHI, Beijing (CN); Hui ZHANG, Beijing (CN); Dong CHENG, Beijing (CN); Wenqiang NIU, Beijing (CN)

(73) Assignee: MASSCLOUDS INNOVATION RESEARCH INSTITUTE (BEIJING) OF INFORMATION TECHNOLOGY, Beijing (CN)

(21) Appl. No.: 15/256,195

(22) Filed: Sep. 2, 2016

(30) Foreign Application Priority Data
Jul. 6, 2016 (CN) 2016105294369

(51) Int. Cl. G06F 9/455

(52) U.S. Cl. CPC G06F 12/109; G06F 9/45558; G06F 9/45545; G06F 2212/1041; G06F 2009/45583; G06F 2212/152; G06F 2212/657; G06F 2212/1008

(57) ABSTRACT

A memory sharing method of virtual machines through the combination of KSM and pass-through, including: a virtual machine manager judging whether operating systems of guests use IOMMU, if not, not participating in shared mapping of a KSM technology; if yes, judging memory pages of each guest to confirm whether the pages are mapping pages, if yes, remain the mapping pages into a host; and if not, on the premise of keeping the properties of Pass-through, using the KSM technology for all non-mapping pages to merge the memory pages with same contents among various virtual machines and perform write protection processing simultaneously. The guest memory pages are divided into those special for DMA and those for non-DMA purpose, then the KSM technology is only selectively applied to the non-DMA pages, and on the premise of keeping the properties of Pass-through, the object of saving memory resources is achieved simultaneously.

### FIELD OF THE INVENTION

The invention relates to a memory sharing method of virtual machines based on the combination of KSM and pass-through.

### BACKGROUND OF THE INVENTION

In a system virtualization technology, memory pages of a guest are supported by the memory pages of a host. For example, a virtual machine manager (VMM) can utilize an Intel EPT technology to map GPA (guest physical address) to HPA (host physical address). Meanwhile, some memory sharing technologies, such as KSM and the like, are also used in system virtualization.

The KSM (kernel same page merging) technology can merge the memory pages with same contents among multiple virtual machines (VM) and simultaneously set write protection. For example, if some memory page in the VM1 (guest PA1->host PA1) has same contents as the another memory page (guest PA2->host PA2) positioned in the VM2, only one memory page (HPA SH) needs to be retained in the host for supporting mapping, that is, the guest PA1 of the VM1 and the guest PA2 of the VM2 are both re-mapped to the same page HPA_SH, and are write-protected. This technology saves system memory, in particular for read-only memory pages in the guest, such as code pages and zero pages. When the virtual machine modifies the contents of the memory page, the KSM utilizes a COW (copy-on-write) mechanism to cancel the shared mapping.

Pass-through is a common technology for improving the performances of the device in a virtualization system. The principle is to re-map the GPA to the HPA through an IOMMU page table. A typical example is Intel VT-d, and a virtual machine supporting the Pass-through is named as PT-VM. The PT-VM guest accesses a physical device MMIO register and sets a physical device DMA (technology of direct access to memory by a peripheral device), both in a direct way, as shown in FIG. 1. The PT-VM is widely used in current virtualization/cloud computing environment, especially in coordination with an SR-IOV technology. SR-IOV only needs tiny hardware update of the device, and then it can provide efficient sharing operation support for the multiple virtual machines. FIG. 2 is a schematic diagram of an SR-IOV technology using IOMMU.

A good system virtualization solution scheme is required to have not only higher operation performances, such as the operation performances achieved by using a Pass-through technology; but also be capable of saving memory, such as the situation achieved by using a KSM memory sharing technology.

However, at present, the KSM memory sharing technology and the DMA direct mode (belonging to the Pass-through technology) can not be used at the same time, there are two reasons:

Firstly, in the DMA direct mode, when the contents of the memory pages are modified, the virtual machine manager (VMM) are not be notified; Secondly, most of existing platforms do not support the triggering of page fault (#PF) in the DMA process.

Thus, VMM has no chance of knowing the changes in the shared memory pages to cancel sharing, so that other virtual machines sharing the memory pages are affected. Therefore, for the host memory pages used in PT-VM (as the mapping targets of the guest memory pages), pre-exclusion must be performed before the KSM mechanism is used so as to avoid the occurrence of shared mapping implemented on these pages. In the existing methods, there is a lack of the corresponding technology to solve this problem.

### SUMMARY OF THE INVENTION

In order to solve the problem, the invention proposes a memory sharing method of virtual machines based on the combination of KSM and pass-through. The method uses the KSM and the Pass-through technologies in combination, thereby obtaining the optimal balance in the aspect of performances and efficiency of the virtual machines and effectively solving the problem of limiting the use of a memory sharing technology in PT-VM.

In order to achieve the above object, a technical solution adopted by the invention is as follows:

A memory sharing method of virtual machines based on the combination of KSM and pass-through is specifically as follows: a virtual machine manager judging whether operating systems of various guests use IOMMU or not, if not, not participating in shared mapping of a KSM technology;
if yes, judging on the memory pages of each guest to confirm whether the pages are mapping pages or not, if yes, remain the mapping pages of the various guests into the host; if not, on the premise of keeping the properties of Pass-through, using the KSM technology for all non-mapping pages to merge the memory pages with same contents among the multiple virtual machines and perform write protection processing at the same time.

Further, the memory sharing method of the virtual machines specifically comprises the following steps:

(1) the virtual machine manager tracking the operating system of each guest, judging whether the operating system of each guest uses the IOMMU or not, if not, not participating in the shared mapping of the KSM technology, and if yes, proceeding to step (2);
(2) the virtual machine manager reading the memory pages of the guest using the IOMMU and judging whether the pages are mapping memory pages or not, if yes, remain the mapping pages of the various guests into the host, and if not, proceeding to step (3);
(3) generating a page identifier list for the non-mapping memory pages of each guest based on a Hash algorithm, wherein page identifiers are Hash values of the page contents;
(4) merging the memory pages with the same page identifier, establishing a shared host page in the host to update the original mapping and write-protect the shared host page.

Further, the specific method of judging whether the operating systems of the guests use the IOMMU or not is as follows: through tracing the operation of the IOMMU by the guest virtual machines, the virtual machine manager determining whether each guest virtual machine enables the IOMMU or not, if the virtual machine uses a Pass-through device, but the operating system of the guest does not enable the IOMMU, taking all the pages of the virtual machine as DMA pages, namely not participating in the shared mapping of the KSM.

Further, based on the write protection mechanism of the IOMMU page table of the guest or the mechanism of tracking IOTLB refreshing, the virtual machine manager perceives the modification of the virtual IOMMU page table by the guest and synchronously modifies an IOMMU shadow page table.

The specific method of judging whether the pages are the mapping memory pages or not is as follows: based on the IOMMU shadow page table, the virtual machine manager confirming whether there are memory pages serving as target pages operated by DMA or not, because all the DMA pages must be mapped by the IOMMU page table of the guest.

Further, when page items of the IOMMU page table of the guest are set, the setting action triggers VM-exit, the virtual machine manager learns PTE contents which are being written by the guest, if the PTE is a mapping conversion of a newly-built item to the target page, the virtual machine manager adds the target page into a linked list of the DMA page.

Further, the virtual machine manager establishes a reverse mapping table and maintains the mapping from the host page frame number to the device space address in the guest IOMMU to trace the alias mapping which may exist, if page items of the IOMMU page table of the guest are deleted or updated, the target page is not used for the DMA page any more, the reverse mapping table is looked up for confirmation, then the target pages confirmed not to be the mapping pages any more are transferred into the linked list of the non-mapping pages.

The specific method of merging the same pages by using the KSM technology is as follows: by adopting a Hash algorithm, producing a page identifier list for each virtual machine, wherein page identifiers are Hash values of the page contents, if two PIs are same, regarding the corresponding contents are same, and when a group of memory pages with the consistent contents is found in the different or the same virtual machines, merging the memory pages into one.

Further, the specific method of merging is as follows: respectively mapping the guest page frame numbers of the virtual machines with the same memory pages to a host page frame number, and the virtual machine manager updating the original mapping based on a shared host page and setting write protection for the two mappings. Further, when the guest modifies the contents of some shared page, due to the set mapping write protection mechanism, the VM-exit is triggered, and once the virtual machine manager detects the trigger signal, the mapping of the shared page is canceled.

The specific method of canceling the shared page is as follows:

(i) additionally allocating a new host page HPN2;
(ii) copying the contents or the original host shared page HPN1 onto the new host page HPN2;
(iii) respectively mapping the guest page frame numbers of the virtual machines with same memory pages to the original host shared page HPN1 and the new host page HPN2 and simultaneously canceling the write protection of the two mappings;
(iv) simulating a guest site environment and restoring the execution at the position of a break point where the VM-exit was triggered previously.

The virtual machine manager corresponds the IOMMU shadow page table to the IOMMU page table in the guest, and the specific measure comprises: setting write protection for the IOMMU page table of the guest or tracking the IOTLB refreshing operation of the guest to ensure that when the guest modifies the IOMMU page table, the IOMMU shadow page table is modified correspondingly.

Further, if the guest modifies the contents of the shared page, the virtual machine manager will cancel the shared mapping.

Further, whether the pages are the mapping memory pages can be changed by the operation of the guest, and specifically, there are three situations:

(a) from the mapping memory pages to the non-mapping memory pages, the guest page frame number to be processed existed in the linked list of the mapping memory pages previously, once the role change of the page is detected, the page is transferred into the linked list of the non-mapping memory pages to perform merging processing of the pages with same contents;
(b) for the conversion from the non-mapping memory pages which are not shared to the mapping memory pages, the guest page frame number to be processed existed in the linked list of the mapping memory pages previously and the shared mapping has not been established yet, the guest frame number is directly transferred into the linked list of the mapping memory pages of the virtual machine to which it belongs;
(c) for the conversion from the non-mapping memory pages which have been shared to the mapping memory pages, a process of canceling the shared mapping is executed to re-map the guest page frame number of the original virtual machine and transfer the original guest page frame number into the linked list of the mapping pages of the corresponding virtual machine.

The invention has the following beneficial effects:

(1) At present, there no other technical solutions which can support the use of the KSM memory sharing and merging technology in the Pass-Through virtual machines. The invention solves the difficult problem and effectively solves the problem of using the KSM memory sharing and merging in the Pass-Through virtual machines;
(2) The Pass-through technology (including SR-IOV) can enable the virtual machines to achieve very high DMA operation performances, but the virtual machines have very poor performances in the aspect of memory page sharing; moreover, the ordinary virtual machines (without the adoption of Pass-through) can merge the memory pages based on KSM sharing, but the device has very poor IO performance; whereas the invention can use the two technologies of Pass-through and KSM in combination, and simultaneously achieve the object of improving the O performance of the device and saving memory resources;
(3) The invention is based on virtualized IOMMU in the guest, the guest memory pages are divided into those special for DMA and those for non-DMA purpose, then the KSM technology is only selectively applied to the non-DMA pages, and on the premise of keeping the properties of Pass-through, the object of saving memory resources is achieved at the same time.

### BRIEF DESCRIPTION OF THE DRAWINGS

FIG. 1 is a schematic diagram of a Pass-through technology of a virtual machine device of the invention;

FIG. 2 is a schematic diagram of SR-IOV of a virtual machine of the invention;

FIG. 3 is a schematic diagram of a KSM mechanism of the invention;

FIG. 4 is a schematic diagram of the isolation/protection process implemented by a native operating system using IOMMU of the invention;

FIG. 5 is a schematic diagram of an IOMMU virtualization process based on a shadow IOMMU page table of the invention; and

FIG. 6 is a schematic diagram of a flow process of the invention, namely a process diagram of a method cooperating KSM with Pass-through.

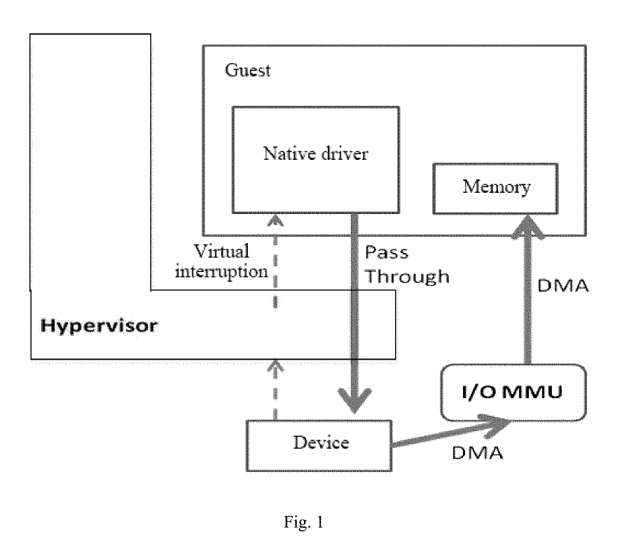

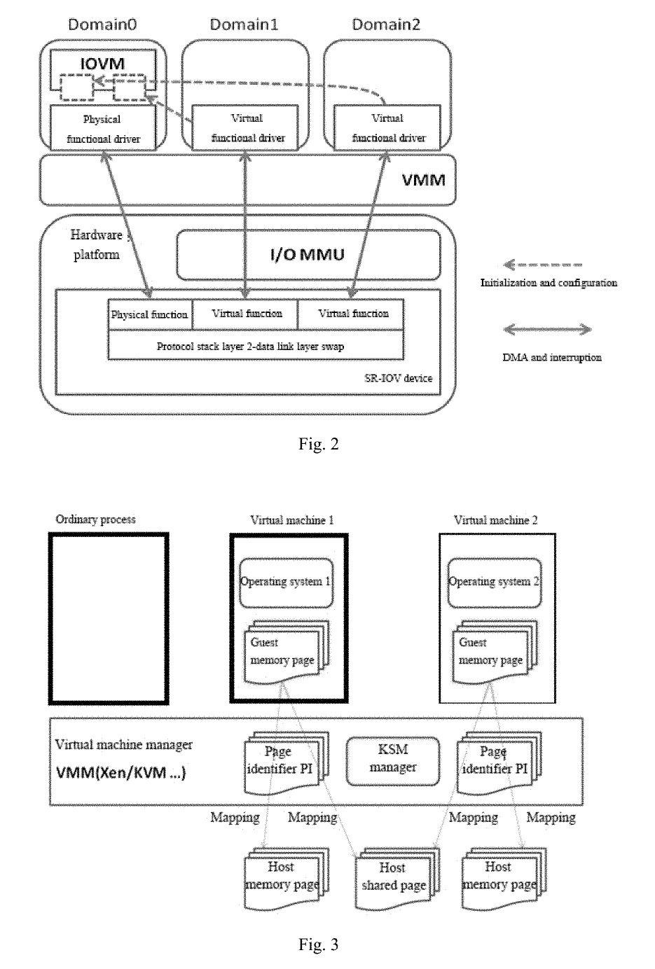

### DETAILED DESCRIPTION OF THE EMBODIMENTS

The utility model is further described below in conjunction with the accompanying drawings and the embodiments.

The object of the invention is to solve the problem of limiting the use of a memory sharing technology in PT-VM, namely obtaining the optimal balance in the aspect of performances and efficiency of the virtual machines by using the KSM and the Pass-through technology in combination. The technical invention will be hereinafter named as SM_PT_VM.

The SM_PT_VM is based on virtualized IOMMU in a guest, the guest memory pages are divided into those special for DMA and those for non-DMA purpose, then the KSM technology is only selectively applied to the non-DMA pages, and on the premise of keeping the properties of Pass-through, the object of saving memory resources is achieved at the same time. The key points are as follows:

1) The virtual IOMMU is provided for the guest operating system (at present, KVM has supported it) and the mechanism of the guest operating system itself is utilized for supporting the protection of DMA target address space.
2) The purposes of the memory pages in the guest are identified, including the non-DMA pages and (possible) DMA pages. The identification can be performed by tracking the IOMMU page table of the guest (at present, the KVM has supported the IOMMU virtualization function on the basis of the IOMMU shadow page table mechanism). Only the pages establishing the mapping in the virtual IOMMU page table may be the DMA pages, and they are set to be special for the DMA (i.e. not allowing being merged and shared by the KSM). Other pages in the guest are used as the non-DMA pages.
3) The strategy of the invention is: selectively applying the KSM technology only to the non-DMA pages. As most of the pages are the non-DMA pages in normal circumstances, the strategy can ensure very high merging efficiency.
4) When the shared pages produced by KSM merging need to establish the mapping in the IOMMU page table (by intercepting the modification action on the IOMMU pages by the guest), the shared mapping of the guest pages (on the basis of COW) should be canceled, namely the new host pages are produced by copying, the two independent mappings are separated and restored, and the pages are identified as the DMA special pages belonging to some virtual machine.
5) When the PTE item corresponding to some page is found to be deleted from the IOMMU page table (it is PDE when the 2M large page is adopted and it is PDPE when 1G large page is adopted) and the page is not mapped by other PTE (PDE/PDPE) item, the page is restored to become the non-DMA page, and then it can be processed by the KSM technology.

### A. Principle of KSM

The mapping management from the guest page frame number (GPN) to the host page frame number (HPN) is a basic technology of system virtualization. Intel EPT (and AMD NPT) is based on a two-dimensional page table for directly completing the mapping under the hardware support; the shadow page table implicitly adopts the similar principle to complete the mapping from the guest virtual address (GVA) to the host physical address (HPA). The mapping may change dynamically due to some reasons, for example, page swap and page sharing (typically such as KSM). Such mapping adapts to the memory management in the operating system, for example, the function of swapping the page contents to a magnetic disk.

The mechanism of the KSM applied in the virtual machine is as shown in FIG. 3. The virtual machine manager (VMM) can be of type I or type II, including Xen, KVM, Vmare, Hyper V, etc., namely the term VMM not only can represent the Hypervisor type which directly runs on the bare machine, but also can represent the host type.

The KSM manager is positioned in the VMM, can run in an independent thread and is responsible for merging the memory pages. The KSM generally adopts a Hash algorithm to produce a page identifier (PI) list for each virtual machine and the page identifier PI is the Hash value of the page contents. If the two PIs are same, the corresponding page contents can be considered to be same.

### 1.1) Merging of the Same Memory Pages

When the KSM manager finds a group of memory pages with the consistent contents in the different or the same virtual machines, the memory pages may be merged into one. For example, GPN1 of VM1 and GPN2 and VM2 are respectively mapped to HPN1 and HPN2, namely

### GPN1 (of VM1)→HPN1

### GPN2 (of VM2)→HPN2

and the contents of the HPN1 and the HPN2 are consistent. Then, VMM may update the original mapping based on a shared host page HPN3 (HPN3 can be HPN1 or HPN2 or new page, but with the contents copied from HPN1/2)
GPN1 (of VM1)→HPN3, with write protection
GPN2 (of VM2)→HPN3, with write protection

At the same time, the VMM sets the write protection for the two mappings through the EPT (NPT) or the shadow page table. In such a way, the KSM reduces the number of the host memory pages as mapping support.

### 1.2) Canceling of Mapping of Shared Pages

Once some guest modifies the contents of some shared page (assuming GPN1), VM-exit is triggered due to the write protection mechanism of the shared page, namely the process of switching CPU from a non-root mode to a root mode and switching from the guest to the virtual machine manager (VMM). Once the VMM detects the condition, the shared mapping is canceled according to the following steps:

a) Allocating a new host page HPN4
b) Copying the contents of the original shared page HPN3 to HPN4
c) Mapping GPN1 of VM1 to HPN3 and canceling write protection
d) Mapping GPN2 of VM2 to HPN4 and canceling write protection
e) Simulating a guest site environment and restoring the execution at the position of a break point where the VM-exit was triggered previously.

### B. Use of IOMMU by Operating System and IOMMU Virtualization

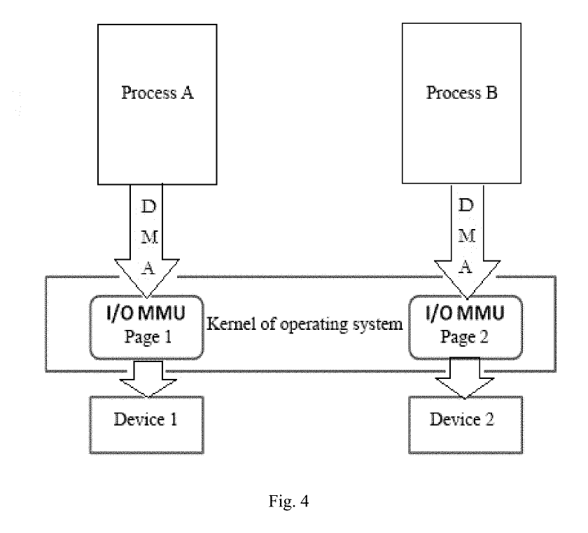

In order to protection of the operation on equipment by different application procedures, the operating system uses the IOMMU to protect the DMA operation. The independent IOMMU page table can be maintained for each PCIe device (by taking BDF-Bus: Dev: Function as the device identifier) to prevent the memory pages pre-allocated to the designated device from being destroyed, namely, the access limitation is performed on the pages protected by the IOMMU. This is shown in FIG. 4.

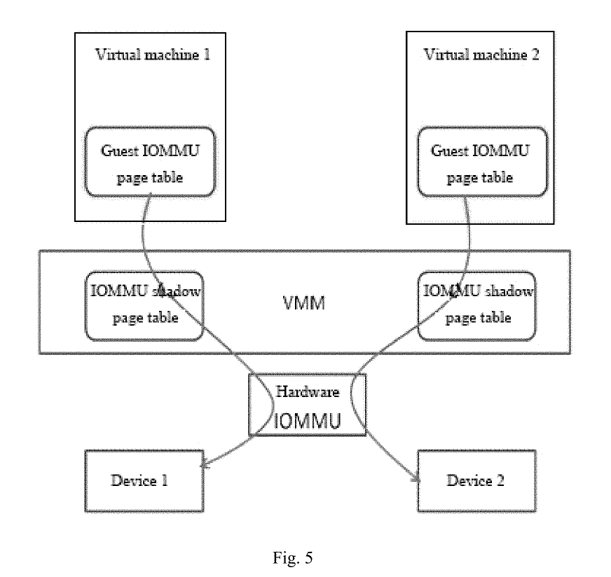

FIG. 5 shows a method for implementing the virtual IOMMU by the typical VMM. The VMM implements the correspondence between one actual IOMMU page table (named as the IOMMU shadow page table) and the IOMMU page table in the guest. In order to ensure the synchronization of the two page tables in the contents, typically, the VMM can set the write protection for the IOMMU page table of the guest, so that when the guest modifies the page table, the VMM timely modifies the corresponding shadow page table. Another optimal scheme is to trace the IOTLB refreshing operation of the guest, namely whenever the guest executes the IOTLB refreshing, the IOMMU shadow page table is correspondingly modified. No matter which scheme is adopted, the VMM can trace the target memory pages of the DMA operation of the monitoring device.

Herein, the term SIOPT-shadow IOMMU page tables represent the actual IOMMU page tables (for the DMA use of the guest); and the term “tracking the changes in the IOMMU page table of the guest” includes two significances of finding the changes in the IOMMU page table and monitoring the IOTLB refreshing.

In order to achieve the virtual IOMMU, the VMM needs to realize the IOMMU shadow page table; and furthermore, when the guest rewrites the IOMMU page table, the trapping is triggered so as to keep the real-time updating of the IOMMU shadow page table.

C. Method for Implementing KSM in SM_PT_VM

In this section, it is assumed that the guest operating system uses the IOMMU. By tracking the operation against the IOMMU by the guest, the VMM can easily determine whether the IOMMU is started or not (because the virtual IOMMU is simulated by the VMM). Note: if the virtual machine uses the Pass-through device, but the guest operating system does not start the IOMMU, the strategy of SM_PT_VM can not be used. All the pages of the virtual machine are taken as the DMA pages, namely the pages which do not participate in shared mapping of the KSM.

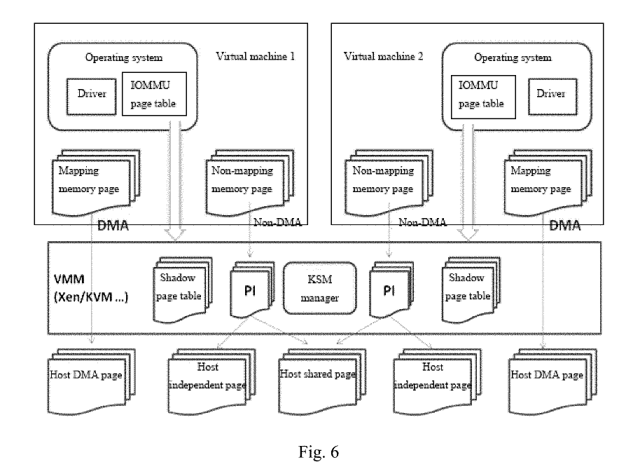

FIG. 6 is a complete schematic diagram of the KSM mechanism used by the SM_PT_VM. In the Pass-through scheme, the guest has the ability of directly operating the DMA of the device, and the DMA implements the protection through the IOMMU. That is, when the guest submits the DMA operation, it needs to set the virtual IOMMU to provide the instruction for the DMA. In such a way, based on the write protection mechanism of the IOMMU page table of the guest or the mechanism of tracking IOTLB refreshing, the VMM can perceive the modification of the virtual IOMMU page table by the guest (see FIG. 5) and synchronously modifies the IOMMU shadow page table.

3.1) Differentiation of DMA Pages and non-DMA Pages

Based on the IOMMU shadow page table, the VMM can know whether some memory page is taken as the target page of the DMA operation or not. All the DMA pages must be mapped by the guest IOMMU page table (and will be further mapped by the IOMMU shadow page table).

The typical implementation way is that, in the initial situation, all the pages of the guest are taken as the non-DMA pages (namely all the pages can be subject to merging processing by the KSM manager). Once the PTE (the table item of the guest IOMMU page table) is set, such an action can trigger the VM-exit (page table write protection triggering or IOTLB triggering), then the VMM can timely know the PTE contents which are being written by the guest. If the PTE is the mapping conversion of the newly built one item to the target page (GPNx) (the present position of the PTE is set), the VMM adds the GPNx into a linked list of the DMA page. This is as shown in FIG. 6.

The VMM can establish a reverse mapping table and maintains the mapping from the HPN (host page frame number) to IOVA (device space address in the guest IOMMU) to trace the alias mapping which may exist. If the PTE (pointing to GPNy) is deleted (the present position is zero-cleared) or covered by the new PTE, it is indicated that the GPNy may not be used for the DMA page any more, and this needs to be confirmed by looking up the reverse mapping table. Once the GPNy is confirmed to be not the DMA page any more, the VMM transfers the page to the linked list of the non-DMA pages.

3.2) Page Sharing of SM_PT_VM

Generally, the KSM manager can process the non-DMA pages and merge the pages with same contents in a shared mapping way. Here, it must be noted that the shared merging can only be applied to the non-DMA pages. Of course, if the guest modifies the contents of the shared page, a process of canceling the shared mapping will be executed, just like the KSM conventional processing process.

Furthermore, in the working process of the SM_PT_VM, the role of the pages (DMA or non-DMA) may change due to the operation of the guest (as described in the section of differentiating the DMA and the non-DMA pages), and there are three situations (taking the page GPN5 as an example):

From the DMA pages to the non-DMA pages: in this case, the GPN5 existed in the linked list previously, once the changes in the page role is detected, the page is transferred into the linked list of the non-DMA pages (the linked list or other data structures can be used), and then the KSM manager can perform merging processing on the pages with same contents, the process is as that described above.

From the non-DMA pages (non-shared) to the DMA pages: in this case, the GPN5 existed in the linked list of the non-DMA pages previously, but the shared mapping has not been established, then the VMM transfers the GPN5 into the linked list of the DMA pages of the virtual machine to which it belongs.

From the non-DMA pages (shared) to the DMA pages: in this case, the shared mapping was established for HPN1 (the GPN1 in the VM1 is mapped into the HPN1) previously, the VMM must execute the process of canceling the shared mapping to copy the HPN1 to the HPN2 (for example), and then re-map the GPN1 of the VM1 to the HPN1 and map the GPN2 of the VM2 to the HPN2. At the same time, the VMM transfers the GPN1 into the linked list of the DMA pages of the VM1 and transfers the GPN2 into the linked list of the DMA pages of the VM2.

Although the preferred embodiments of the invention have been described above in conjunction with the accompanying drawings, the scope of protection of the invention is not limited thereto. Those skilled in the art should understand that on the basis of the technical solution of the invention, various modifications and variations that can be made by those skilled in the art without creative labor are still within the scope of protection of the invention.

1. A memory sharing method of virtual machines based on the combination of KSM and pass-through, characterized by comprising a virtual machine manager judging whether operating systems of various guests use IOMMU or not, if not, not participating in shared mapping of a KSM technology;
if yes, judging on the memory pages of each guest to confirm whether the pages are mapping pages or not, if yes, remain the mapping pages of the various guests into the host;
if not, on the premise of keeping the properties of Pass-through, using the KSM technology for all non-mapping pages to merge the memory pages with same contents among the multiple virtual machines and perform write protection processing at the same time.

2. The memory sharing method of the virtual machines based on the combination of KSM and pass-through according to claim 1, comprising the following steps:
(1) the virtual machine manager tracking the operating system of each guest, judging whether the operating system of each guest uses the IOMMU or not, if not, not participating in the shared mapping of the KSM technology, and if yes, proceeding to step (2);
(2) the virtual machine manager reading the memory pages of the guest using the IOMMU and judging whether the pages are mapping memory pages or not, if yes, remain the mapping pages of the various guests into the host, and if not, proceeding to step (3);
(3) generating a page identifier list for the non-mapping memory pages of each guest based on a Hash algorithm, wherein page identifiers are Hash values of the page contents;
(4) merging the memory pages with the same page identifier, establishing a shared host page in the host to update the original mapping and write-protect the shared host page.

3. The memory sharing method of the virtual machines based on the combination of KSM and pass-through according to claim 1, wherein the specific method of judging whether the operating systems of the guests use the IOMMU or not is as follows: through tracing the operation of the IOMMU by the guest virtual machines, the virtual machine manager determining whether each guest virtual machine uses the IOMMU or not, if the virtual machine uses a Pass-through device, but the operating system of the guest does not use the IOMMU, taking all the pages of the virtual machine as DMA pages, namely not participating in the shared mapping of the KSM.

4. The memory sharing method of the virtual machines based on the combination of KSM and pass-through according to claim 1, wherein based on the write protection mechanism of the IOMMU page table of the guest or the mechanism of tracking IOTLB refreshing, the virtual machine manager perceives the modification of the virtual IOMMU page table by the guest and synchronously modifies an IOMMU shadow page table.

5. The memory sharing method of the virtual machines based on the combination of KSM and pass-through according to claim 1, wherein the specific method of judging whether the pages are the mapping memory pages or not is as follows: based on the IOMMU shadow page table, the virtual machine manager confirming whether there are memory pages serving as target pages operated by DMA or not, because all the DMA pages must be mapped by the IOMMU page table of the guest.

6. The memory sharing method of the virtual machines based on the combination of KSM and pass-through according to claim 3, wherein when page items of the IOMMU page table of the guest are set, the setting action triggers VM-exit, the virtual machine manager learns PTE contents which are being written by the guest, if the PTE is a mapping conversion of a newly-built item to the target page, the virtual machine manager adds the target page into a linked list of the DMA page.

7. The memory sharing method of the virtual machines based on the combination of KSM and pass-through according to claim 1, wherein the virtual machine manager establishes a reverse mapping table and maintains the mapping from the host page frame number to the device space address in the guest IOMMU to trace the alias mapping which may exist, if page items of the IOMMU page table of the guest are deleted or updated, the target page is not used for the DMA page any more, the reverse mapping table is looked up for confirmation, then the target pages confirmed not to be the mapping pages any more are transferred into the linked list of the non-mapping pages.

8. The memory sharing method of the virtual machines based on the combination of KSM and pass-through according to claim 1, wherein t the specific method of merging the same pages by using the KSM technology is as follows: by adopting a Hash algorithm, producing a page identifier list for each virtual machine, wherein page identifiers are Hash values of the page contents, if two PIs are same, regarding the corresponding contents are same, and when a group of memory pages with the consistent contents is found in the different or the same virtual machines, merging the memory pages into one.

9. The memory sharing method of the virtual machines based on the combination of KSM and pass-through according to claim 8, wherein the specific method of merging is as follows: respectively mapping the guest page frame numbers of the virtual machines with same memory pages to a host page frame number, and the virtual machine manager updating the original mapping based on a shared host page and setting write protection for the two mappings.

10. The memory sharing method of the virtual machines based on the combination of KSM and pass-through according to claim 1, wherein when the guest modifies the contents of some shared page, due to the set mapping write protection mechanism, the VM-exit is triggered, and once the virtual machine manager detects the trigger signal, the mapping of the shared page is canceled.

11. The memory sharing method of the virtual machines based on the combination of KSM and pass-through according to claim 10, wherein the specific method of canceling the shared page is as follows:
(i) additionally allocating a new host page HPN2;
(ii) copying the contents or the original host shared page HPN1 onto the new host page HPN2;
(iii) respectively mapping the guest page frame numbers of the virtual machines with same memory pages to the original host shared page HPN1 and the new host page HPN2 and simultaneously canceling the write protection of the two mappings;
(iv) simulating a guest site environment and restoring the execution at the position of a break point where the VM-exit was triggered previously.

12. The memory sharing method of the virtual machines based on the combination of KSM and pass-through according to claim 1, wherein the virtual machine manager corresponds the IOMMU shadow page table to the IOMMU page table in the guest, and the specific measure comprises: setting write protection for the IOMMU page table of the guest or tracking the IOTLB refreshing operation of the guest to ensure that when the guest modifies the IOMMU page table, the IOMMU shadow page table is modified correspondingly.

13. The memory sharing method of the virtual machines based on the combination of KSM and pass-through according to claim 12, wherein if the guest modifies the contents of the shared page, the virtual machine manager will cancel the shared mapping.

14. The memory sharing method of the virtual machines based on the combination of KSM and pass-through according to claim 10, wherein, whether the pages are the mapping memory pages can be changed by the operation of the guest, and specifically, there are three situations:
(a) from the mapping memory pages to the non-mapping memory pages, the guest page frame number to be processed existed in the linked list of the mapping memory pages previously, once the role change of the page is detected, the page is transferred into the linked list of the non-mapping memory pages to perform merging processing of the pages with same contents;
(b) for the conversion from the non-mapping memory pages which are not shared to the mapping memory pages, the guest page frame number to be processed existed in the linked list of the mapping memory pages previously and the shared mapping has not been established yet, the guest frame number is directly transferred into the linked list of the mapping memory pages of the virtual machine to which it belongs;
(c) for the conversion from the non-mapping memory pages which have been shared to the mapping memory pages, a process of canceling the shared mapping is executed to re-map the guest page frame number of the original virtual machine and transfer the original guest page frame number into the linked list of the mapping pages of the corresponding virtual machine.
